(19) United States
(12) Patent Application Publication
(10) Pub. No.: US 2003/0218328 A1
(43) Pub. Date: Nov. 27, 2003

(54) Method and system for securing the visual identity of travelers to their travel documents

(76) Inventor: Kent Thomas Conwell, Naples, FL (US)

Correspondence Address: WERNER H SCHROEDER, 5550 HERON POINT DRIVE, APT 1105, NAPLES, FL, 34108, US

(21) Appl. No.: 10/152,866

(22) Filed: May 22, 2002

(51) Int. Cl. B42D 3/00

(52) U.S. Cl. 281/31

(57) ABSTRACT

The invention is directed to a method and system for securing the visual identity of a traveler to their travel documents. The method includes the steps of receiving a picture based form of identification from a traveler requesting travel documents, visually verifying the traveler matches the identification, obtaining the traveler's travel documents and subsequently, or simultaneously with obtaining the traveler's travel documents, then securing the picture based identification or an image of the traveler to the travel documents. Securing can be accomplished by physically securing the picture identification to a common holder which holds both the picture based identification card and the travel documents, or physically securing a reproduction of the picture based identification or a portion thereof to the travel documents themselves, physically securing a currently captured picture of the verified traveler to the travel documents themselves, or electronically storing for subsequent retrieval at security checkpoints an image of the picture based identification or a portion thereof or a currently captured picture of the verified traveler whereby said picture is indexed in a database and linked to the travel documents by a unique identifier.

### CROSS REFERENCE TO RELATED APPLICATIONS

(none)

### STATEMENT REGARDING FED SPONSORED R & D

(none)

### FIELD OF THE INVENTION

The present invention relates generally to the travel industry and more particularly to methods and systems for verifying the identity of travelers and that travelers are in possession of travel documents in which they are the named traveler.

### BACKGROUND OF THE INVENTION

The travel industry has an increasing need to ensure the identity of a traveler and to prevent the use of tickets and boarding passes, herein also referred to as travel documents, by persons other than the ticketed passenger. Current methods are insufficient in that the travel documents only identify the ticketed passenger by name and possibly other textual information. When the traveler checks in at the ticket counter, FAA regulations and airline personnel have long required the traveler to present a picture based form of identification, such as a passport or driver's license, in order that they may visually verify the traveler's identity prior to issuing their boarding passes. However, after a traveler leaves the ticket counter, it is possible for someone other than the ticketed passenger to come into possession of the issued travel documents. Due to increased occurrences and threats of terrorism related to air travel, much of the airport premises and all commercial passenger aircraft are restricted to only ticketed passengers and authorized support personnel. Accordingly, airport and airline security operations now have multiple security check points at which travelers are required to present picture based forms of identification along with their travel documents. Airport and airline security personnel review the picture based forms of identification to visually verify the identities of the travelers presenting the identification cards and travel documents and to verify that the names on the identification cards and travel documents are the same. Albeit necessary, this requirement and associated process creates both delays in airport and airline operations and is an inconvenience to travelers.

The repeated storage and retrieval of the separate identification card and travel documents cause much of the delay and inconvenience. Travelers are commonly carrying bags, wallets or purses, cellular phones and other items. Accordingly, they find it difficult to consistently and quickly store and retrieve the separate identification cards and travel documents. Furthermore, as travelers search for the required identification cards and travel documents there can be considerable confusion which detracts from an orderly screening of travelers and their identification cards and documents by airport and airline security personnel. In addition, the separate handling of the identification card and travel documents does not provide a consistent spatial orientation of the two items, making it difficult for airport and airline security to quickly and consistently review the items and perform the necessary verifications. It is therefore desirable to have a method, apparatus and system for securing a picture based form of identification to travel documents which easily allows the consistent presentation of the picture based identification and travel documents to airport and airline security personnel.

Ticket folders are currently employed by the travel industry to retain travel documents. Ticket folders have been contemplated which provide additional functionality such as those described by Zoland in U.S. Pat. No. 5,228,722 and Alford, Jr. in U.S. Pat. No. 3,970,332. Zoland describes a ticket folder whereby a time wheel is included in the folder for time zone conversion by the traveler. Alford, Jr. teaches an airline ticket folder in which the ticket folder provides a plurality of folded panels which contain travel information pertaining to the destination of the traveler. While the ticket folders currently employed and those described by Zoland and Alford, Jr. provide for the retention of travel documents, they do not provide for the retention of a picture based form of identification. Therefore the current forms of travel documents in use as well as the current forms of ticket folders in use do not provide for the securing of a picture based form of identification to the travel documents. Alternatively, identification card holders have long been used for security purposes. These card holders allow a person to visibly display their identification by wearing the holder containing the identification in a prominent location. Such card holders are described in U.S. Pat. Nos. 4,00,570, 4,305,215, 4,869,004, 6,025,564, and 6,226,905. While these card holders serve to enable the validation that a person wearing an identification card possesses a card, and a verification that their likeness matches the picture contained on the card, there are no means provided to present associated travel documents and to facilitate their review by security personnel.

### OBJECTS AND SUMMARY OF THE INVENTION

It is recognized that the travel industry likely has a sizable inventory and order commitments for the currently employed ticket folders. It is an object of the present invention to provide a method and apparatus to utilize currently employed ticket folders to secure a picture based identification card to the ticket folder, thereby also securing the identification card to travel documents retained in the ticket folder.

It is also recognized that the cost to secure an identification card to travel documents would optimally be minimal. Another object of the present invention is to provide a new ticket and identification card folder which utilizes cost effective methods of manufacture.

It is also recognized that travelers may want to own a reusable picture based form of identification and travel document holder which facilitates the review of the identification card and travel documents by airport and airline security personnel. Another object of the invention is to provide an identification and travel document holder which facilitates the review of the identification and travel documents by airport and airline security personnel and which is fashioned in a durable material such as leather.

It is further recognized that airport and airline security operations would be greatly enhanced by providing a verified photograph of the traveler non-removably attached directly to the travel documents. A further object of the present invention is to provide a method and system for capturing and non removeably attaching a verified photograph of the traveler on the travel documents.

Yet another object of the present invention is to provide a method and system for capturing a current, verified photograph of the traveler, associating a unique identifier to the photograph for later retrieval of the photograph, storing the photograph of the traveler in a database indexed by the unique identifier and encoding the unique identifier on the travel document in machine readable form and to further provide for the retrieval of the current photograph of the traveler at the various security checkpoints by reading the unique identifier on the travel document and retrieving the photograph from the database for viewing and confirmation by security personnel.

A method and system for securing the visual identity of a traveler to their travel documents in accordance with the present invention includes the steps of receiving a picture based form of identification from a traveler requesting travel documents, visually verifying the traveler matches the identification, obtaining the traveler's travel documents and subsequently, or simultaneously with obtaining the traveler's travel documents, then securing the picture based identification or an image of the traveler to the travel documents. Securing can be accomplished by physically securing the picture identification to a common holder which holds both the picture based identification card and the travel documents, or physically securing a reproduction of the picture based identification or a portion thereof to the travel documents themselves, physically securing a currently captured picture of the verified traveler to the travel documents themselves, or electronically storing for subsequent retrieval at security checkpoints an image of the picture based identification or a portion thereof or a currently captured picture of the verified traveler whereby said picture is indexed in a database and linked to the travel documents by a unique identifier.

Apparatus in accordance with the present invention provides for the retention of at least one picture based form of identification together with at least one travel document or facilitates the rapid modification of a conventional ticket folder to accomplish the same.

### BRIEF DESCRIPTION OF THE DRAWINGS

FIG. 1 depicts a conventional ticket folder;

FIG. 2 illustrates the conventional ticket folder of FIG. 1 modified in accordance with one embodiment of the present invention;

FIG. 3 depicts another style of conventional ticket folder;

FIG. 4 illustrates the conventional ticket folder of FIG. 3 modified in accordance with one embodiment of the present invention;

FIG. 5, FIG. 6 and FIG. 7 depict picture based identification card holders. Each figure contains subfigures A-D whereby subfigure A shows a horizontal orientation of the holder in exploded view, subfigure B shows a vertical orientation of the holder in assembled view, subfigure C shows a horizontal orientation of the holder in assembled view with a card inserted and subfigure D shows a vertical orientation of the holder in assembled view with a card inserted;

FIG. 8 is a ticket folder which has an integral picture based identification card holder in accordance with one embodiment of the present invention;

FIG. 9 is a combination travel document and picture based identification holder in accordance with one embodiment of the present invention;

FIG. 10 is a system block diagram representative of some of the embodiments of the present invention in which an image of the visual identity of a traveler is captured and attached to travel documents of the traveler;

FIG. 11 illustrates a boarding pass in accordance with some of the embodiments of the present invention;

FIG. 12 illustrates a boarding pass in accordance with some of the embodiments of the present invention;

FIG. 13 is a system block diagram representative of some of the embodiments of the present invention in which an image of the visual identity of a traveler is captured and associated to travel documents of the traveler for retrieval of the image at security checkpoints;

FIG. 14 is a system block diagram of a security checkpoint representative of some of the embodiments of the present invention for use in conjunction with the system of FIG. 13.

### DETAILED DESCRIPTION OF THE INVENTION

Methods, systems and apparatus for securing the visual identity of a traveler to their travel documents are disclosed. The following description is presented to enable any person skilled in the art to make and use the present invention. For purposes of explanation, specific nomenclature is set forth to provide a thorough understanding of the present invention. Descriptions of specific applications are provided only as examples. Various modifications to the embodiments given will be readily apparent to those skilled in the art, and the general principles defined herein may be applied to other embodiments without departing from the spirit and scope of the invention. Thus, the present invention is not intended to be limited to the embodiments shown, but is intended to be accorded the widest scope consisted with the principles and features disclosed herein.

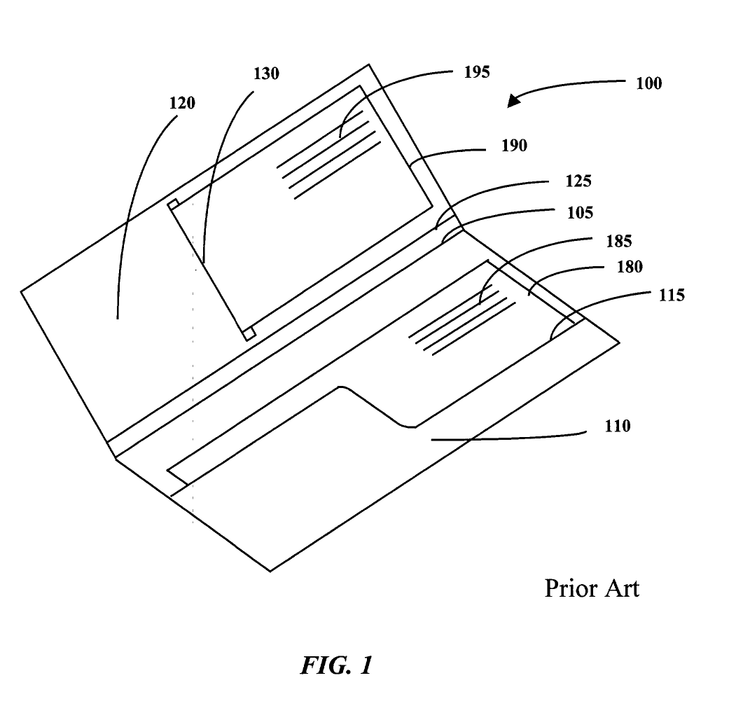

Referring now to the drawings, FIG. 1 depicts an example of a conventional ticket folder representative of those in use by the airlines. Ticket folder 100 is constructed of paper stock which is generally printed, cut, folded and glued to create the ticket folder. This example of a conventional ticket folders provides pockets 110 and 120 for retention of the travelers travel documents. Travel documents inserted into pocket 110 are done so through slot 115. Pocket 110 is designed to leave a substantial portion of the travel document exposed. This pocket is generally used for retaining boarding passes 180. Text 185 contained on boarding passes 180 can be quickly examined for travel details such as the passenger name, flight number, and scheduled flight departure time. Pocket 120 is designed to retain documents using two methods. In one of the two methods, the pocket receives the travel document through slot 125. Documents thus inserted are substantially covered by pocket 120. This method is generally used to store tickets. In the other of the two methods, the pocket receives the travel documents through slot 130. Documents 190 thus inserted are substantially exposed allowing text 195 to be readily examined. Multiple boarding passes can be retained by folder 100 in either pockets 110 or 120 or a combination thereof. Ticket folder 100 is closed about fold 105 to further retain and protect the travel documents contained therein.

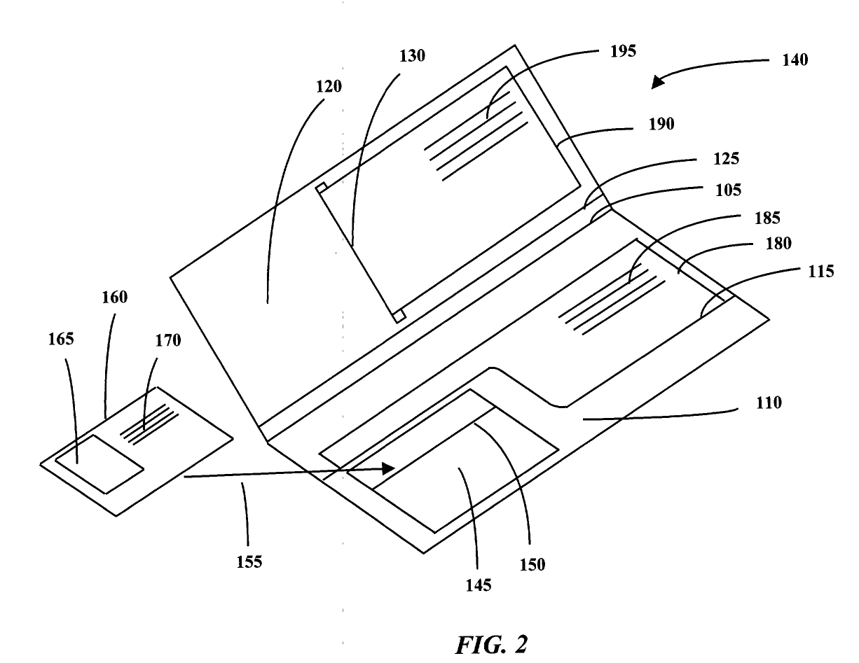

Referring now to FIG. 2, the conventional ticket folder of FIG. 1 is shown modified in accordance with one of the embodiments of the present invention. As can be seen in FIG. 2, ticket folder 140 has been modified to include pocket 145. Pocket 145 is constructed of a substantially transparent plastic material, is designed to receive a picture based identification card 160 in slot 150 and serves to securely retain the identification card. Picture based identification cards are placed in pocket 145 as indicated by arrow 155 and are readily visible either by way of the exposed portion of the card or through the substantially transparent plastic. The rear surface of pocket 145 is coated with an adhesive for readily attaching pocket 145 to ticket folder 100 to form ticket folder 140. As in FIG. 1, also shown in FIG. 2 are boarding passes 180 and 190. Boarding pass 180 is inserted in pocket 110. Boarding pass 190 is inserted in pocket 120 through slot 130. Preferably and as depicted in FIG. 2, the traveler names 185 and 195 that are respectively contained on boarding passes 180 and 190, are advantageously spatially oriented to the name 170 contained on identification card 160 and thus can be readily verified to match. Picture 165 is also presented in an advantageous orientation for examination.

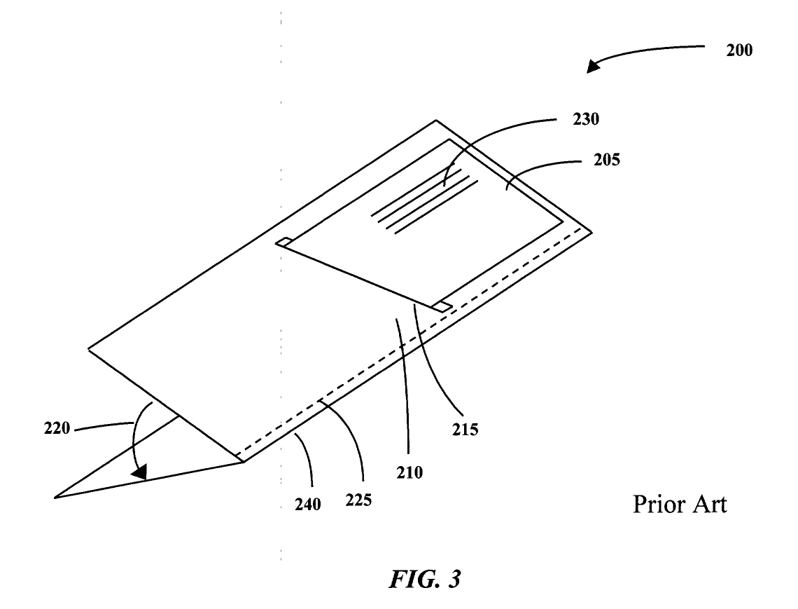

FIG. 3 depicts another type of a conventional ticket folder representative of those currently used by airlines. Ticket folder 200 shown in FIG. 3 has pocket 210 accessed through slot 215 for retention of travel documents, generally boarding passes 205. A portion of boarding pass 205 thus inserted is exposed for access and viewing of text 230 containing travel details. Boarding pass 205 and text 230 contained thereon can be accessed from the outside of the ticket folder when the ticket folder is closed in the direction indicated by arrow 220 about fold 240. Pocket 210 is also accessible from the opposite side from slot 215 through slot 225. Slot 225 is indicated by a dotted line. Slot 225 runs substantially parallel and relatively close to fold 240 and is accessible when ticket folder 200 is opened in the opposite direction from that indicated by arrow 220 about fold 240. Tickets are generally inserted in slot 225 and are fully or largely enveloped by pocket 210.

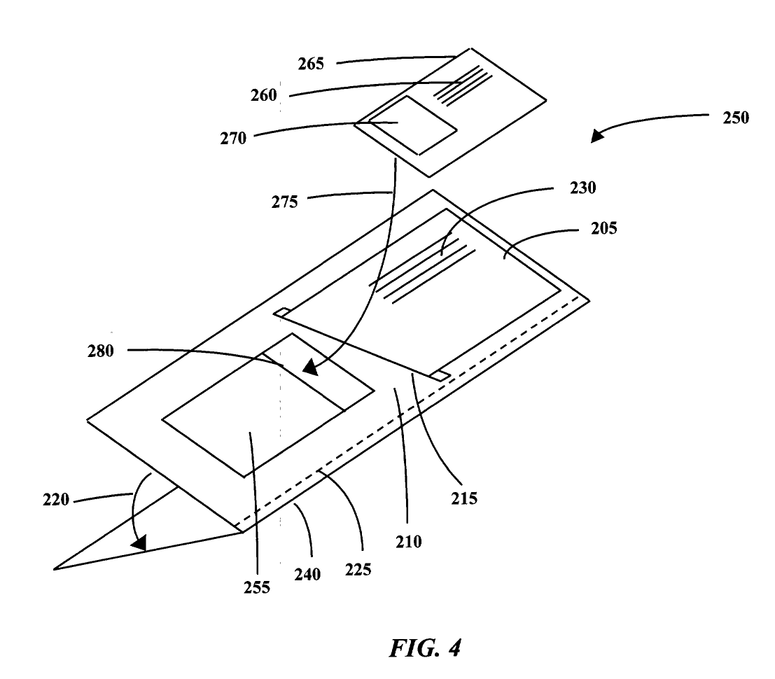

Ticket folder 200 when modified in accordance with the present invention is shown in FIG. 4. As can be seen in FIG. 4, ticket folder 250 has been modified to include pocket 255 for securely retaining a picture based identification card 265. Pocket 255 is located near the exposed portion of boarding pass 205 and text 230. Picture based identification card 265 is inserted into pocket 255 through slot 280 in the direction indicated by arrow 275. The orientation of picture based identification card 265 when placed in pocket 255 and the orientation of boarding pass 205 are preferably the same to facilitate reading and matching of the names contained in text 260 and 230. Picture 270 is also thus presented in an advantageous orientation for examination.

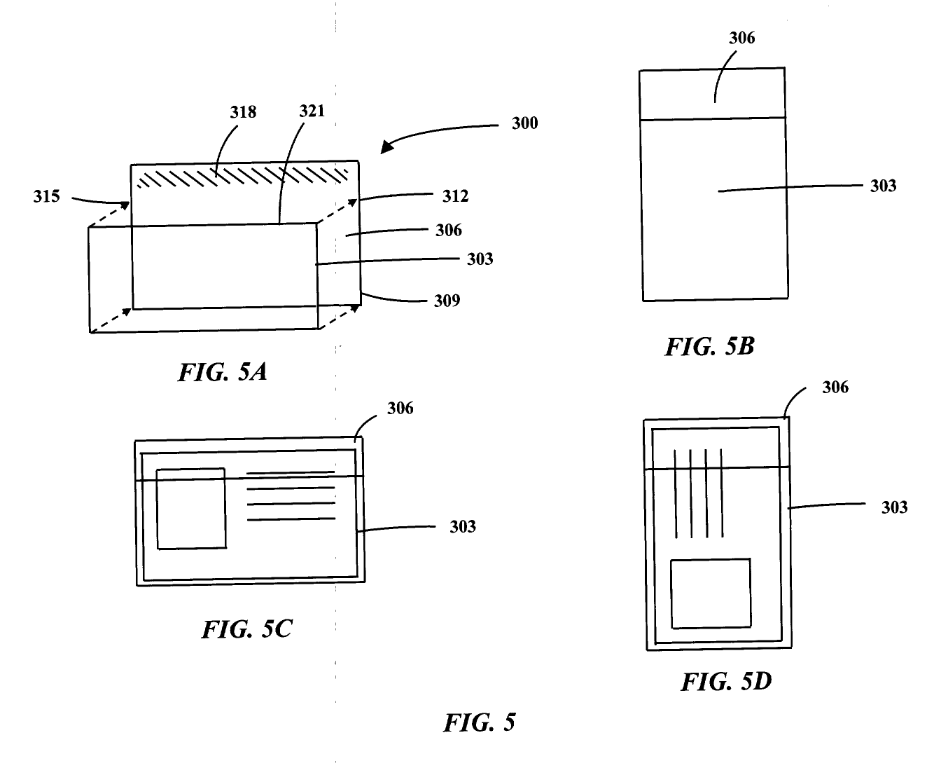

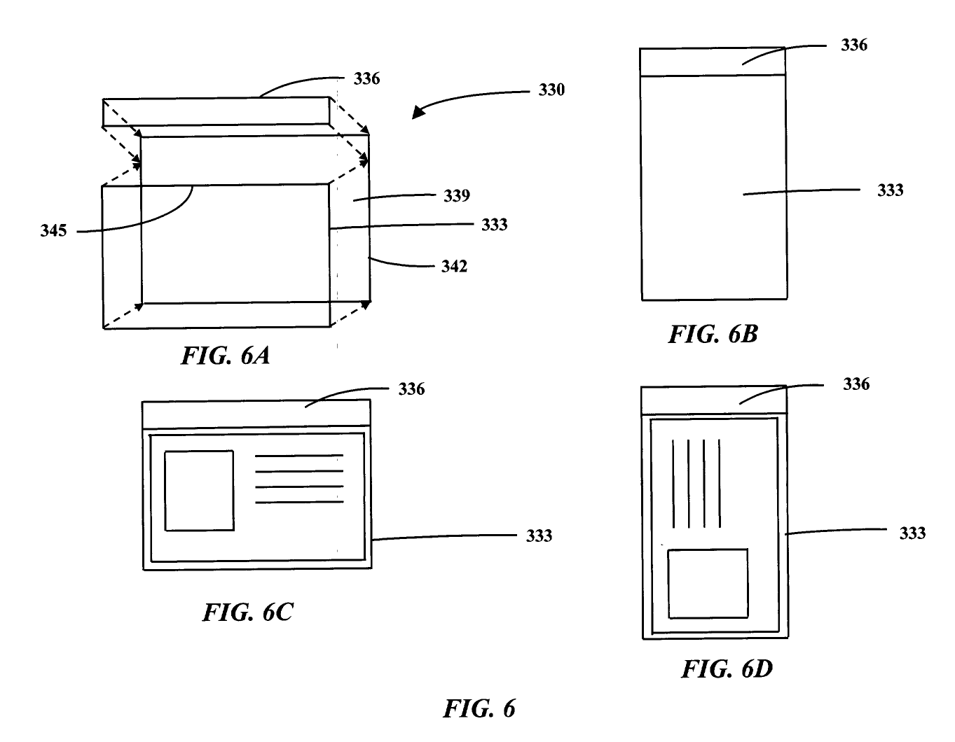

Various embodiments of picture based identification card holders can be used to provide pockets for securing picture based identification card to a ticket folders. FIG. 5, FIG. 6 and FIG. 7 depict various embodiments of picture based identification card holders. Holders 300, 330, and 360 respectively in FIG. 5, FIG. 6 and FIG. 7 are shown when constructed in horizontal and vertical orientations and are shown with and without identification cards inserted. Four depictions are therefore provided for each of the three holders 300, 330 and 360. Only the horizontal orientation without an identification card is numbered for detailed discussion, but the discussion applies equally to each of the four depictions. Holders 300, 330 and 360 are constructed of substantially clear plastic thereby providing for viewing of picture based identification cards places therein. Holder 300 shown in FIG. 5 consists of front wall 303 and rear wall 306 which are attached along perimeter 309 from point 312 to point 315. Attachment is commonly done by the application of heat or by sonic welding. Rear wall 306 is slightly larger than a picture based identification card. Front wall 303 is shorter in height than rear wall 306 and stops at slot 321. Picture based identification cards are inserted into the pocket created by front wall 303 and rear wall 306 through slot 321. Rear wall 306 can have a weak adhesive applied in the area indicated by hash marks 318 for additional retention cards placed in holder 300. The majority of the card is captured in the pocket. A portion of the card is exposed for access to remove the card. The rear surface of rear wall 306, which can also be referred to as the rear surface of holder 300, is coated with an adhesive for attaching holder 300 to a ticket folder. The adhesive coating would normally be covered with what is commonly referred to in the art as a release backing until use. This release backing prevents the adhesive from reacting with air and the holder from adhering to unwanted items prior to use. To attach the holder 300 to a ticket folder, the release backing is pealed off of the adhesive coated rear surface of holder 300 and holder 300 is then placed onto the ticket folder.

Holder 330 shown in FIG. 6 has front walls 333 and 336 and a rear wall 339 attached at perimeter 342. Perimeter 342 runs the length of all four sides of rear wall 339. Front walls 333 and 336 are separated by slot 345. The height of front wall 333 is slightly larger than the height of picture based identification cards, thereby allowing a card to be inserted downwardly into slot 345 and into the pocket formed by front wall 333 and rear wall 339. Front walls 333 and 336 elastically separate and close about slot 345 as the card is inserted. Once elastically closed, slot 345 serves to prevent the card from inadvertently falling out of holder 330. Holder 330 has adhesive and release backing applied to its rear surface as described for holder 300.

Holder 360 shown in FIG. 7 has a front wall 363, rear wall 366 and flap 378. Rear wall 366 is slightly larger than a picture based identification card. Front wall 363 is shorter in height than rear wall 366 and stops at slot 390. Picture based identification cards are inserted into the pocket created by front wall 363 and rear wall 366 at slot 390. The majority of the card is captured in the pocket. A portion of the card is exposed for access to remove the card. Flap 378 and rear wall 366 are either formed from a common piece of substantially transparent plastic and are differentiated by the fold at edges 381 and 384 or are two separate pieces of substantially transparent plastic attached at edges 381 and 384. Flap 378 elastically opens and closes about the fold or attachment as the card is inserted. Once elastically closed, flap 378 serves to prevent the card from inadvertently falling out of holder 360. To further secure the card from falling out, flap 378 can be of sufficient length to be partially inserted into the pocket at slot 390. Alternatively, flap 378 can have adhesive applied on the surface indicated by hash marks 387 to adhere it to front wall 363. Holder 360 has adhesive and release backing applied to its rear surface as described for holder 300. Descriptions of holders 300, 330 and 360 are provided for illustrative purposes and significant variations are possible without departing from the scope of the present invention.

Card holders 300, 330 and 360 can be designed to include indications of a particular status of the traveler. For example, the border or a strip portion of the holder could be color coded to indicate a particular elite level of a frequent travel program. In addition, the card holders could include an additional portion of space for advertisements printed thereon or for advertisements printed on paper where the paper is subsequently attached on the additional space or inserted into an additionally provided pocket contained in the additional space. Alternatively the pocket for the identification card could be for advertisements. For example, the holder could have an advertisement printed on the front face of the rear wall of the card holder. This advertisement would be in conspicuous view and visible through the front wall of the holder as the card is removed. Alternatively, the advertisement could be contained on a piece of paper situated behind the identification card. Again, this advertisement would be in conspicuous view and visible through the front wall of the holder as the card is removed. Advertisements such as those for a car rental agency, hotel or restaurant would be some of those that can be envisioned to beneficially use the holder for such a form of advertising.

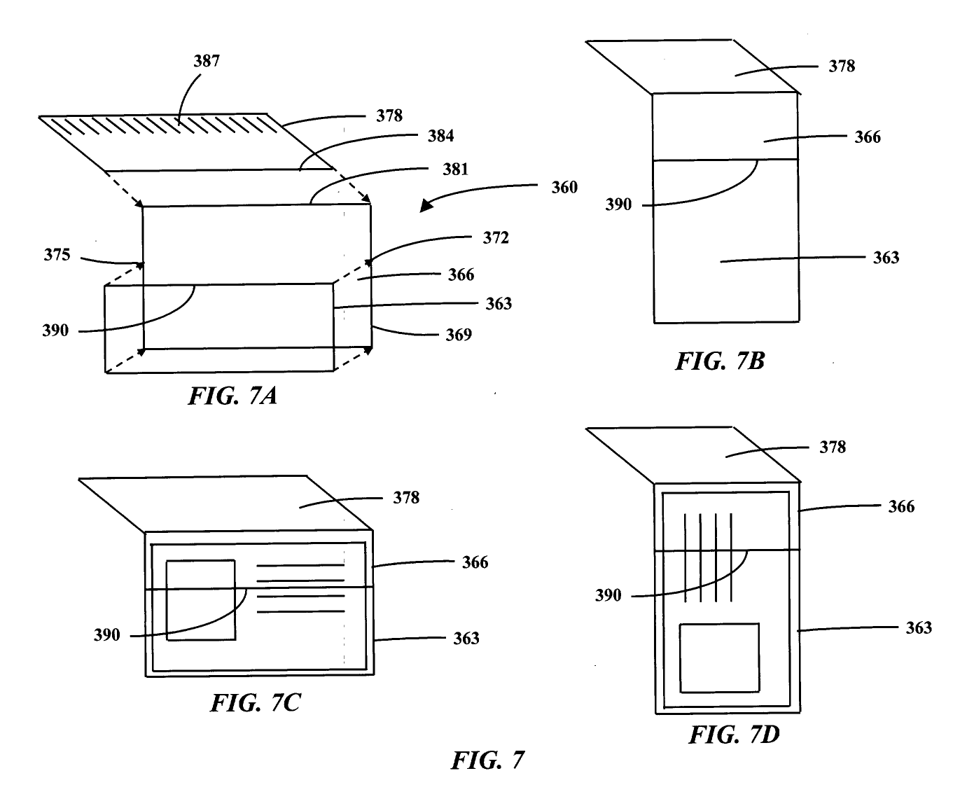

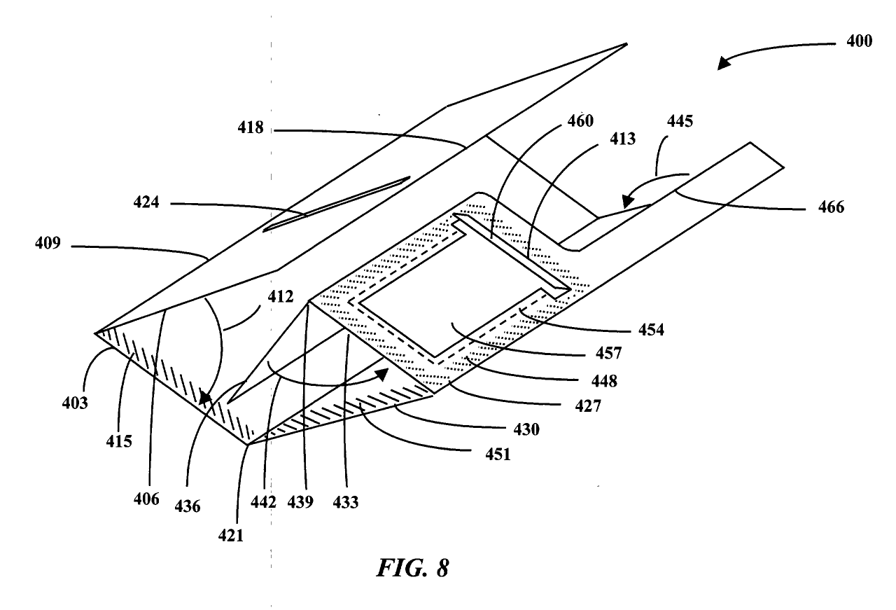

Ticket folder 400 shown in FIG. 8 is designed to securely retain a picture based identification card in addition to retaining travel documents. This ticket folder can be manufactured at a lower cost than the total cost of combining a conventional ticket jacket with a plastic card holder as shown in FIG. 2 and FIG. 4. Ticket folder 400 can be manufactured from a single sheet of paper stock which is printed, die cut, applied with adhesive in selective locations thereon, and be folded. Folder 400 is shown with folds partially completed for illustrative purposes.

The left side of folder 400 consists of walls 403 and 406 which meet at fold 409. When completely folded in the direction indicated by arrow 412, the lower portions of walls 403 and 406 are adhered together with adhesive applied in the region indicated by hash marks 415 and thereby create a pocket. Edge 418 of wall 406 creates a slot, herein after referred to as slot 418, for access to the pocket for retaining tickets. Slot 424 in wall 406 provides for additional storage for travel documents in the pocket where a portion of the travel documents remains exposed.

The right side of folder 400 consists of walls 430, 433 and 436. Walls 430 and 433 meet at fold 427. Walls 433 and 436 meet at fold 439. Wall 433 has a portion removed to form window 457 and cuts to form flap 460. Adhesive is applied to the rear side of wall 433 in the location indicated by dotted hash marks 448 for adhering wall 436 to wall 433 when completely folded about fold 439 in the direction indicated by arrow 442. The adhesive is not applied within the area just outside the window as defined by the window and dotted line 454. The substantially rectangular region defined by dotted line 454 and flap fold 413 is slightly larger than a picture based identification card. This region represents a pocket having a window where the pocket is formed by walls 433 and 436 and allows insertion of a card therein through flap 460. The majority of window 457 can be enclosed in substantially transparent cellophane or similar material by adhering the material to the rear of wall 433. This would provide for additional retention of cards placed in the pocket and also allow the window to be as large or larger than the card. After walls 433 and 436 are folded and adhered together, they are collectively folded about fold 427 in the direction indicated by arrow 445. The bottom of wall 430 and the collective walls 433 and 436 are adhered together by adhesive applied in the area indicated by hash marks 451 thereby forming a pocket. Edge 466 of wall 433 and fold 439 collectively form creates a slot, herein after referred to as slot 466, into which boarding passes can be retained and partially exposed for viewing.

Folder 400 therefore enables boarding passes to be inserted into 424 and 466 and picture based identification cards to be inserted into the slot defined by flap 460 where the boarding passes and identification card have the same orientation thereby facilitating quick verification that names contained thereon match. In addition, the picture on the identification card is advantageously oriented for examination.

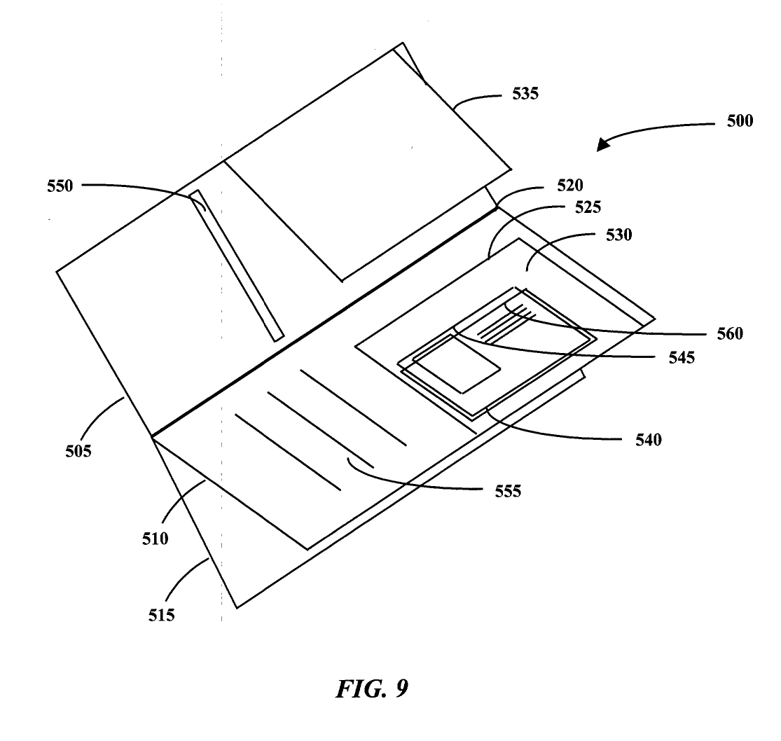

Paper based ticket folders are generally intended for single or very limited use. FIG. 9 depicts an embodiment of the present invention that is reusable. This reusable embodiment of the present invention is hereinafter referred to as the “document traveler”, and is fashioned in a durable material such as leather. Document traveler 500 could be purchased by the traveler or possibly given to the traveler as part of an airline frequent traveler elite level program.

Document traveler 500 has three main walls 505, 510 and 515 attached at spine 520. Holder 530 on wall 510 is designed for insertion of the first page of a passport through slot 525. The first page of the passport contains the picture and name of the passport holder which is viewable through the substantially transparent plastic face on holder 530. Flap 535 of wall 505 then covers the balance of the passport protecting and retaining the remaining pages. Alternatively a card form of picture based identification can be inserted into slot 560 of holder 540 co-located on holder 530 where the card is viewable through the substantially transparent plastic forming holder 540. In this construction, the portion of the passport under holder 540 is viewed through two layers of plastic, one layer being the face of holder 540 and the other layer being holder 525. Slot 550 in wall 505 provides for insertion of boarding passes, into the pocket contained in wall 505. Boarding passes thus inserted are partially exposed. Document traveler 500 therefore allows boarding passes and picture based identification to be held in common orientation in walls 505 and 510 facilitating quick confirmation that names contained thereon match. The picture on the identification is also advantageously oriented for examination. Alternatively slot 550 can receive a paper based ticket folder, arranged in a manner to properly expose the boarding pass contained therein after insertion of the ticket folder into slot 550. Wall 510 can be equipped with slots 555 for credit or other cards. The opposing sides off wall 510 and 515 can be equipped with additional pockets, not shown, for additional travel documents or with slots, pockets and/or pouches, not shown, such as those common in wallets for storing paper currency, coin currency, writing instruments, pictures, paper, receipts and/or additional cards.

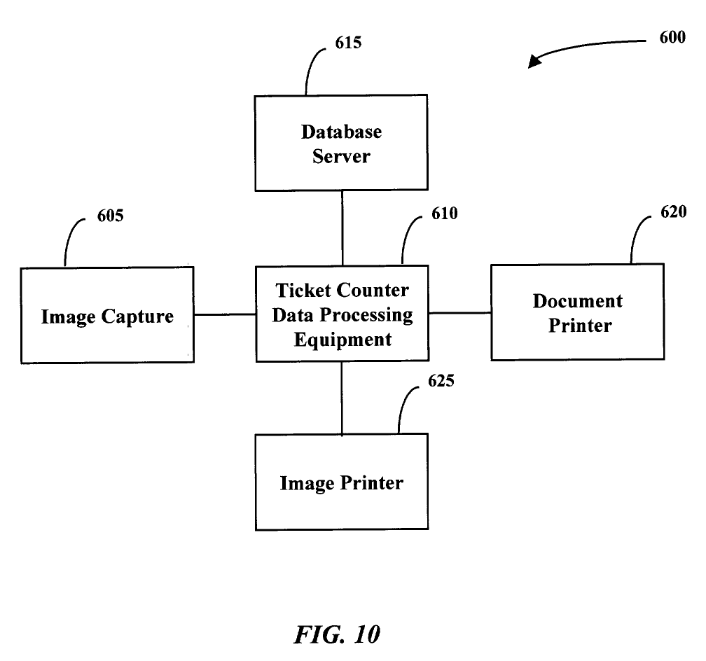

FIG. 10 is a block diagram of further embodiments of the present invention which are methods and systems to capture the image of the visual identity of the traveler and to secure the captured image directly on the traveler's travel documents. These embodiments thereby relieve security personnel from having to verify that names on picture based identification matches those on travel documents. Various embodiments of system 600 shown in FIG. 10 are provided by the present invention. In one embodiment, the captured image is secured to the travel documents by printing the image directly thereon. In another embodiment, the captured image is first printed on labels which are then non removabley attached to the travel documents. Another variant of the embodiments of system 600 is that the captured image can be that of the picture based form of identification or a portion thereof, or the captured image can be that of the traveler themselves. The later image has the benefit of being a current image of the traveler, including their current hair styling and dress. System 600 can be implemented to provide any combination of the variants including those that provide the capability to print both on labels and directly on travel documents and/or to capture both the image of traveler and the image of the picture based form of identification.

System 600 contains image capture device 605 for capturing the image. For an embodiment where the image to be captured is a picture based form of identification or a portion thereof, the image capture device would be an image scanner or digital camera. For an embodiment where the image to be captured is that of the traveler, the image capture device would be a digital camera. Data representing the image is communicated to ticket counter data processing equipment 610 and is optionally communicated between ticket counter data processing equipment 610 and database server 615 for storage for future retrieval and audit. For systems which print the image directly on the travel document two alternatives are provided. In one version the travel document is printed with the image by document printer 620. In this version, ticket counter data processing equipment 610 retrieves traveler travel document information sends the travel document data and image data to document printer 620 for printing. In the other version, the travel document is first printed without the image by document printer 620 and the image is subsequently printed on the travel document by image printer 625. In this second version, ticket counter data processing equipment 610 first retrieves traveler travel document information and sends to ticket printer 620 for printing. The resulting travel document is then loaded in image printer 625 and ticket counter data processing equipment 610 sends image data to image printer 625 for printing of the image on the travel document.

For systems which print the image on a label for attachment to the travel document, ticket counter data processing equipment 610 sends the image data to label printer 625 for printing and the traveler travel document data to ticket printer 620 for printing. Labels are printed for each boarding pass printed. As the boarding passes and labels are finishing printing or after they complete printing, the labels are attached to the boarding passes. Preferably the label would have some form of watermarking scheme, hologram or other method to indicate its authenticity and would provide visible evidence when tampered with.

It can be readably envisioned by those skilled in the art that the image capture and image printing devices could be implemented as a separate system where said system is not operatively connected to the ticket counter data processing system. This separate image capture and printing system can be a self contained device which accepts the picture based form of identification, image scans the identification, optionally displays the scan for acceptance by the operator, receives a quantity and print command from the operator and prints the requested number of labels or prints the requested number of images on travel documents. Alternatively, this separate system can comprise separate components including an image scanner a data processing unit and an image printer.

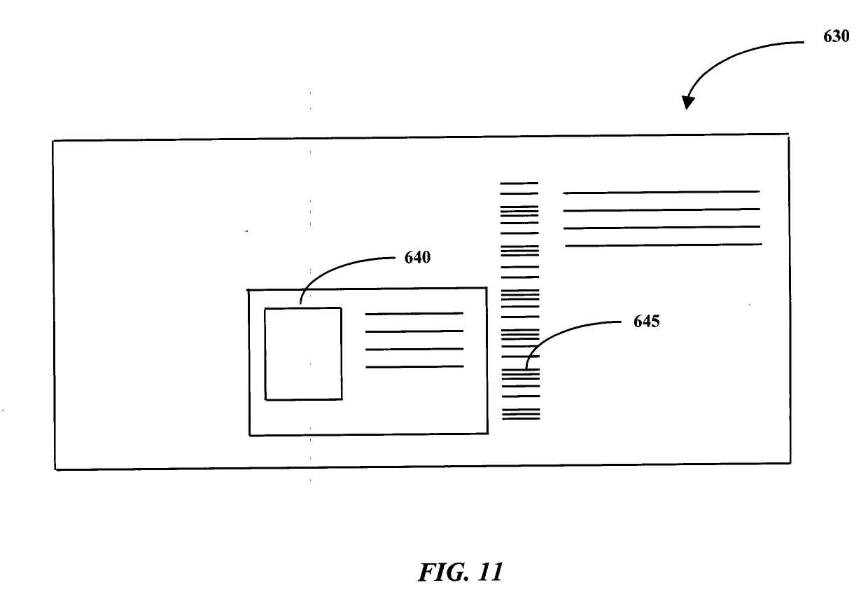

FIG. 11 shows boarding pass 630 with the image of a picture based form of identification 640 printed on boarding pass 630 or attached to the boarding pass by use of the label. The image or the picture based form of identification captured at the ticket counter may require cropping to provide the most effective use of the space provided for the image on the travel document. Accordingly, image 640 can be a cropped image that contains a portion of the full image of the picture based form of identification. Systems can be implemented to provide operator assisted cropping or automated cropping based on image recognition and processing algorithms.

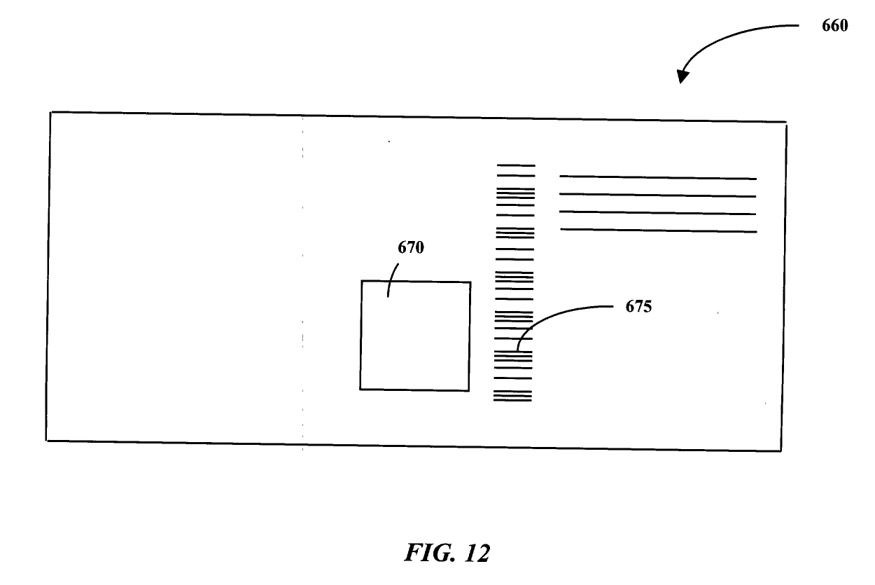

FIG. 12 shows boarding pass 660 with the image of traveler 670 printed on boarding pass 660 or attached to the boarding pass by use of the label. Image 670 can be a portion of the image of a picture based form of identification cropped only to include the image of the traveler or image 670 can be a current image of the traveler taken at the ticket counter. The current image of the traveler captured at the ticket counter may require cropping to provide the most effective use of the space provided for the image on the travel document. Accordingly, image 670 can be a cropped image that contains a portion of the original image of the traveler captured at the ticket counter. Systems can be implemented to provide operator assisted cropping or automated cropping based on image recognition and processing algorithms.

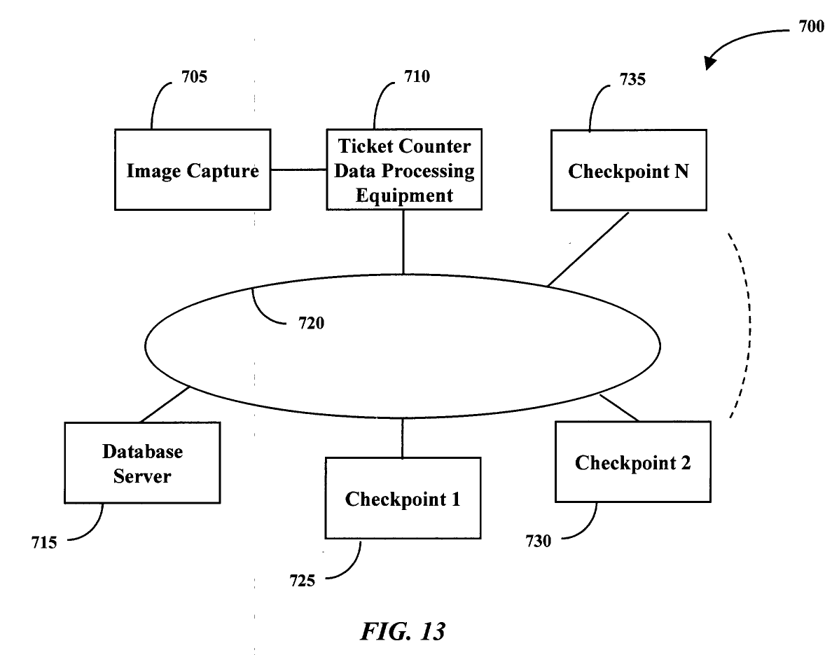

FIG. 13 shows another embodiment of the present invention which is a method and system to capture the image of a picture based form of identification or the image of the traveler at the ticket counter and to display the image at security checkpoints. System 700 contains image capture device 705 for capturing the image. For an embodiment where the image to be captured is a picture based form of identification or a portion thereof, the image capture device would be an image scanner or digital camera. For an embodiment where the image to be captured is that of the traveler, the image capture device would be a digital camera. Data representing the image is communicated to ticket counter data processing equipment 710. The captured image can be cropped so that the cropped image contains a portion of the full image of the picture based form of identification or the traveler. Systems can be implemented to provide operator assisted cropping or automated cropping based on image recognition and processing algorithms. Ticket counter data processing equipment 710 then assigns a unique index number to the image. This unique index number can preferably be the document number or document numbers for which the image is captured. It is recognized that more than one document number can be associated with the current travel. The image is mapped or indexed under each such associated travel documents. The image data and index data are then communicated between ticket counter data processing equipment 710 and database server 715 through network 720 for storage of the image data in a database location mapped to the one or more index numbers associated with the current travel for future retrieval and audit.

The unique index numbers associated with the image are encoded onto their corresponding documents and preferably done so in the same operation as the printing of the document to avoid printing or encoding the index on the wrong travel document. However, systems in accordance with the present invention could alternatively encode the index numbers in steps separate from the printing of the travel documents. Preferably the index is encoded onto the document in machine readable form. One method for encoding the index numbers in a machine readable form is to encode the numbers in a barcode which can be printed onto the document. FIG. 11 and FIG. 12 have barcodes 645 (FIG. 11) and 675 (FIG. 12) for reading by a barcode reader. Another method for encoding the index numbers in a machine readable form would be to encode the index numbers in a magnetic stripe on the document for reading by a magnetic stripe reader.

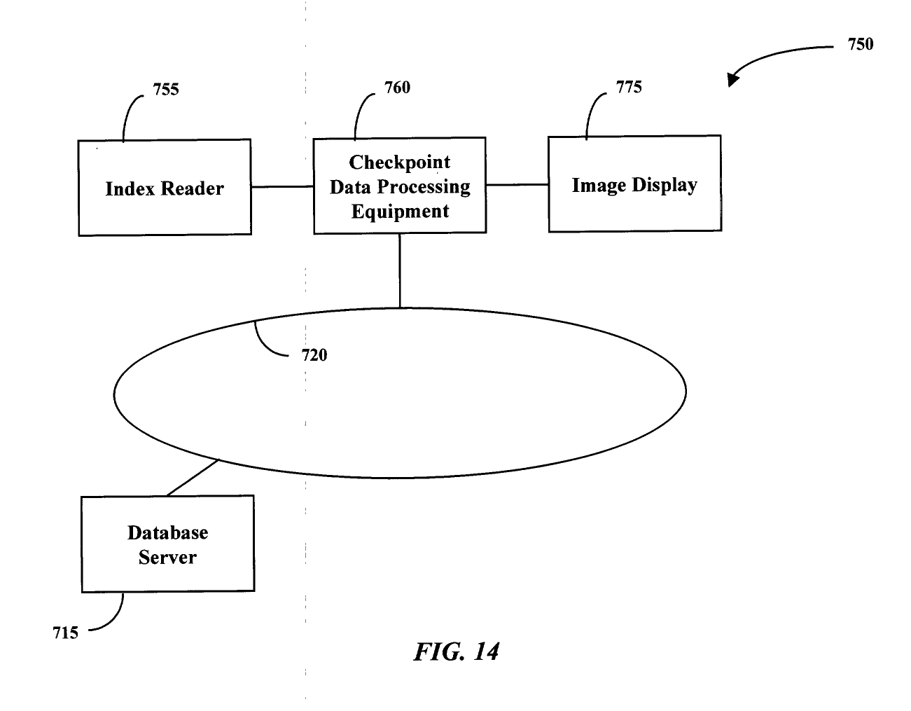

One or more security checkpoints are connected to the network. For illustrative purposes, FIG. 13 shows security checkpoints 725, 730 and 735 connected to network 720. The topology of network 720 can be considered to span multiple airports. Therefore checkpoints 725, 730 and 735 can be associated with the current airport or other airports interconnected with network 720. FIG. 14 is a block diagram of the security checkpoint system 750 for use with the system of FIG. 13. Also shown for clarity in FIG. 14 are network 720 and database server 715. As the traveler moves through the security checkpoints at current or subsequent airports, the traveler presents the relevant boarding pass for the current airport. In accordance with the present invention security checkpoint system 750 contains index reader 755 which reads the index number on the boarding pass presented by the traveler, checkpoint data processing equipment retrieves the image by using the index number to index the image stored in database server 715 and the retrieved image is displayed on image display 775 for visual verification of the traveler by security personnel. Systems 750 can also be networked to communicate with airline data processing equipment (not shown). In such configurations, where the index number is the same as the document number, the index number can also be used to access the airline database and confirm that the boarding pass is pertinent to the current airport and date of travel as an additional security measure. Systems within the scope of the present invention can also use facial recognition based biometric algorithms to automate or enhance the effectiveness of the security checkpoint. In this embodiment, a digital camera (not shown) would be connected to checkpoint data processing equipment 760 for capture of the image of the traveler presenting the boarding pass at the security checkpoint. The image data captured at the checkpoint would be algorithmically compared to the image data retrieved from the database for verification of a match. A match or failure to match would be indicated on image display 775.

A variation of systems 700 and 750 can be used in which the image of the traveler itself in encoded on the travel document rather than or in addition to the database index for the image. In this variation, security checkpoints could read the encoded image, decode the image and display the image without accessing the network or database. This variation is useful for configurations where the database and network infrastructure are not present or are not accessible.

It can be envisioned by those skilled in the art how the present invention could be applied to forms of travel other than the airline industry. The foregoing detailed description should be regarded as illustrative rather than limiting and the appended claims, including all equivalents, are intended to define the scope of the invention.

What I claim is:

1. A ticket folder for securing the identity of a traveler in the form of a picture based form of identification to the travel documents of the traveler comprising:
at least one pocket for retention of at least one travel document; and
a pocket for retention of a picture based form of identification.

2. The ticket folder of claim 1 wherein said pocket for retention of travel documents and said pocket for retention of a picture based form of identification are integrally formed in said ticket folder.

3. The ticket folder of claim 2 wherein the orientation of a travel document when placed in said pocket for retention of travel documents and the orientation of a picture based form of identification when placed in said pocket for retention of a picture based form of identification are the same when viewing both the travel document and the picture based form of identification.

4. The ticket folder of claim 3 wherein said ticket folder is largely comprised of paper and said pocket for retention of a picture based form of identification has a window formed by removal of paper wherein the area of the removed paper is smaller than the area of said picture based form of identification such that said picture based form of identification cannot pass through said window when it is substantially coplanar with said window.

5. The ticket folder of claim 3 wherein said ticket folder is comprised largely of paper and said pocket for retention of the picture based form of identification has a window formed by removal of paper wherein a portion of the area of the removed paper is enclosed by a substantially transparent material.

6. The ticket folder of claim 1 wherein said ticket folder is comprised of a conventional ticket folder wherein said pocket for retention of travel documents is integrally formed in said conventional ticket folder and said pocket for retention of a picture based form of identification is an integral part of a holder attached to the conventional ticket folder.

7. The ticket folder of claim 6 wherein the orientation of a travel document when placed in said pocket for retention of travel documents and the orientation of a picture based form of identification when placed in said pocket for retention of a picture based form of identification are the same when viewing both said travel document and said picture based form of identification.

8. The ticket folder of claim 6 wherein said attached holder having a pocket for retention of a picture based form of identification has an adhesive applied to the rear of said holder for attachment to said ticket folder.

9. The ticket folder of claim 6 wherein said attached holder having a pocket for retention of a picture based form of identification includes an advertisement.

10. The ticket folder of claim 6 wherein said attached holder having a pocket for retention of a picture based form of identification includes a portion visually indicating a characteristic of the traveler.

11. The ticket folder of claim 6 wherein said attached holder having a pocket for retention of a picture based form of identification has an adhesive which is disposed on a portion of a wall forming the pocket thereby providing additional retention of said identification.

12. The ticket folder of claim 6 wherein said attached holder having a pocket for retention of a picture based form of identification has a slot which elastically opens and closes around said picture based form of identification when it is inserted thereby providing additional retention of said picture based form of identification.

13. The ticket folder of claim 6 wherein said attached holder having a pocket for retention of a picture based form of identification has a flap which covers an area in which said picture based form of identification is inserted into the pocket thereby providing additional retention of said picture based form of identification.

14. A reusable holder for securing the identity of a traveler in the form of a picture based form of identification to travel documents of the traveler comprising:
at least one pocket for retention of at least one travel document; and
at least one pocket for retention of a picture based form of identification.

15. The reusable holder of claim 14 wherein the orientation of a travel document when placed in the pocket for retention of travel documents and the orientation of a picture based form of identification when placed in the pocket for retention of a picture based form of identification are the same when viewing both the travel document and the picture based form of identification.

16. The reusable holder of claim 15 wherein said pocket for a picture based form of identification accepts a page of a passport containing the passport holder's picture.

17. The reusable holder of claim 16 including a flap for retaining and protecting the pages of the passport not disposed in said pocket for a picture based form of identification.

18. The reusable holder of claim 16 further including a pocket for retaining a picture based identification card attached to a surface of said pocket which accepts a page of a passport containing the passport holder's picture.

19. The reusable holder of claim 18 wherein a portion of a passport page inserted into said pocket which accepts a page of a passport is visible through an outer surface of said pocket for retaining a picture based identification card.

20. The reusable holder of claim 15 further including a pocket for retaining paper currency.

21. The reusable holder of claim 15 further including a pocket for retaining coin currency.

22. The reusable holder of claim 15 further including at least one pocket for retaining at least one credit card.

23. The reusable holder of claim 15 further including a pocket for retaining a writing instrument.

24. The reusable holder of claim 15 further including a pocket for retaining writing paper.

25. A system for securing the identity of a traveler in the form of a digital image of the traveler to travel documents of the traveler comprising:
a digital image capture device for capturing a digital image of the traveler; and
a printer for printing said digital image of the traveler for securing said digital image to at least one travel document.

26. The system of claim 25 wherein said digital image is a digital image of a picture based form of identification.

27. The system of claim 25 wherein said digital image is a digital image of a portion of picture based form of identification including the picture of the traveler contained thereon.

28. The system of claim 25 wherein said digital image is a digital photograph of the traveler captured during the current date of travel.

29. The system of claim 25 wherein said digital image is secured to said travel document by printing said digital image directly on said travel document.

30. The system of claim 25 wherein said digital image is secured to said travel document by printing said digital image onto a label which is attached to said travel document.

31. The system of claim 30 wherein said label provides at least one indication of its authenticity.

32. The system of claim 31 wherein said indication of authenticity is a watermark.

33. The system of claim 31 wherein said indication of authenticity is a hologram.

34. The system of claim 30 wherein said label provides visible evidence of tampering upon tampering.

35. The system of claim 25 further including a database for storage and retrieval of said digital image.

36. A system for securing the identity of a traveler in the form of a digital image of the traveler to the travel documents of the traveler comprising:
a digital image capture device for capturing a digital image of the traveler;
a database for storage and retrieval of said digital image indexed by at least one index in said database; and
an encoder for encoding said index of said digital image onto at least one travel document.

37. The system of claim 36 wherein said digital image is a digital image of a picture based form of identification.

38. The system of claim 36 wherein said digital image is a digital image of a portion of a picture based form of identification including the picture of the traveler contained thereon.

39. The system of claim 36 wherein said digital image is a digital photograph of the traveler captured during the current date of travel.

40. The system of claim 36 wherein said index is encoded in machine readable form.

41. The system of claim 36 further including at least one security checkpoint for retrieval of said digital image, said security checkpoint comprising:
an index reader for reading said index on said travel document; and
an image display for displaying a retrieved digital image of the traveler.

42. The system of claim 41 further including a digital camera for capturing a digital image of the traveler at said security checkpoint for algorithmic comparison with said a digital image which is stored in said database.

43. The system of claim 42 wherein said image display displays the result of said algorithmic comparison.

44. A method for securing the identity of a traveler to their travel documents comprising the steps of:
receiving a picture based form of identification from a traveler requesting travel documents;
visually verifying said traveler matches said identification; and
securing said picture based identification to said travel documents.

45. A method for securing the identity of a traveler to their travel documents comprising the steps of:
receiving a picture based form of identification from a traveler requesting travel documents;
visually verifying said traveler matches said identification;
capturing a digital image of said traveler;
and securing said digital image to said travel documents.
